(19) United States
(12) Patent Application Publication
(10) Pub. No.: US 2026/0037192 A1
(43) Pub. Date: Feb. 5, 2026

(54) INSPECTION SYSTEM

(71) Applicant: CANON KABUSHIKI KAISHA, Tokyo (JP)

(72) Inventor: TORU MIYAZAWA, Chiba (JP)

(21) Appl. No.: 19/283,793

(22) Filed: Jul. 29, 2025

(30) Foreign Application Priority Data
Jul. 31, 2024 (JP) 2024-124834

(51) Int. Cl. G06F 3/12; G06T 7/00

(52) U.S. Cl. CPC G06F 3/121; G06F 3/1208; G06F 3/1234; G06T 7/001; G06T 2207/30144

(57) ABSTRACT

An inspection system includes an image-forming unit that forms an image on a sheet, an inspection unit that inspects a sheet on which an image has been formed, and a control unit that controls the image-forming unit so as to form an image on a sheet in a first mode that executes an entirety of a print job, or in a second mode that partially attempts the print job. In both of the first and second modes, the inspection unit executes the inspection. In a case where a fault has been detected as a result of the inspection, the image-forming unit is controlled to re-form an image corresponding to a fault sheet in the first mode, and the image-forming unit is controlled not to re-form an image corresponding to a fault sheet in the second mode.

### BACKGROUND

### Field of the Technology

The present disclosure relates to an inspection system.

### Description of the Related Art

An image-forming apparatus forms an image on a sheet based on input image data representing an image to be printed, and outputs a print material. In a case where a large number of pages or a large number of copies are printed at a time, such as on an occasion of commercial printing, there are times when so-called test printing, which attempts to print only a part of a job, is performed. Japanese Patent Laid-Open No. 2021-184155 discloses a system that makes it easy for a job administrator to check an execution status of a job in test printing and an execution status of a job in real printing.

There is also known technology that automatically inspects whether printing has been performed appropriately by comparing a read image, which is generated by optically reading a print material, with a reference image. Japanese Patent Laid-Open No. 2023-159012 discloses a system that performs an inspection on variable data, such as a character string and a barcode, in accordance with user settings, in addition to an inspection on a picture portion of a print material based on comparison between images. Japanese Patent Laid-Open No. 2023-176860 discloses a system in which a print material for which a fault has been detected as a result of an inspection is discharged to an escape tray different from a normal discharge destination, and the same image can be re-printed on another sheet.

However, there is no known document that explicitly discloses how re-printing should be performed in a case where a fault has been detected in an inspection in a system that includes a function of performing not only real printing, but also test printing.

### SUMMARY

It is considered that an inspection function is not activated at the time of test printing. However, in that case, a person visually checks a print material that has been output in the test printing, and there is a risk that points to be improved cannot be sufficiently discovered before real printing. On the other hand, if the inspection is performed uniformly and even re-printing is attempted, then consumable materials, such as sheets and toner, are wasted. The present disclosure intends to provide a mechanism that enables appropriate control on re-printing in a case where a fault has been detected in an inspection.

According to an aspect, there is provided an inspection system, including; an image-forming unit configured to form an image on a sheet; an inspection unit configured to inspect a sheet on which an image has been formed; and a control unit configured to control the image-forming unit so as to form an image on a sheet in a first operation mode that executes an entirety of a print job for forming an image on a plurality of sheets, or in a second operation mode that partially attempts the print job, wherein the inspection unit is configured to, in both of the first operation mode and the second operation mode, execute an inspection on a sheet on which an image has been formed by the image-forming unit, and the control unit is configured to: in a case where a fault has been detected as a result of the inspection, in the first operation mode, cause the image-forming unit to re-form an image corresponding to a sheet on which the fault has been detected, and, in a case where a fault has been detected as a result of the inspection, in the second operation mode, not cause the image-forming unit to re-form an image corresponding to a sheet on which the fault has been detected.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram showing an example of a configuration of an inspection system according to an embodiment.

FIG. 2 is a block diagram showing an example of a configuration of a control apparatus according to an embodiment.

FIG. 3 is a block diagram showing an example of a configuration of an inspection control unit according to an embodiment.

FIG. 4 is an explanatory diagram showing an example of a print setting screen.

FIG. 5 is an explanatory diagram showing an example of an inspection setting screen.

FIG. 6A is an explanatory diagram showing a first example of a test printing setting screen.

FIG. 6B is an explanatory diagram showing a second example of the test printing setting screen.

FIG. 6C is an explanatory diagram showing a third example of the test printing setting screen.

FIG. 7 is a flowchart showing an example of a flow of printing control processing according to an embodiment.

FIG. 8 is a flowchart showing an example of a flow of real printing processing with re-printing.

FIG. 9 is a flowchart showing an example of a flow of test printing processing without re-printing.

FIG. 10 is a flowchart showing an example of a flow of printing control processing according to a modification example.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Overview of System

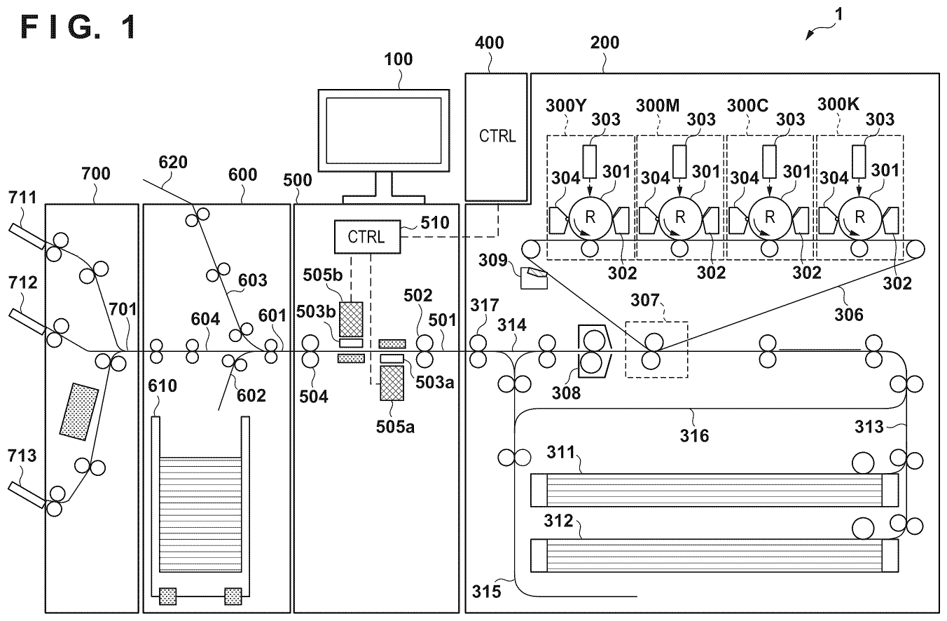

FIG. 1 is a schematic diagram showing an example of a configuration of an inspection system 1 according to an embodiment. Referring to FIG. 1, the inspection system 1 includes an operation unit 100, an image-forming apparatus 200, a control apparatus 400, an inspection apparatus 500, a stacker 600, and a finisher 700.

### (1) Operation Unit

The operation unit 100 is an apparatus that provides a user with user interfaces composed of an input interface and an output interface. The input interface may include, for example, one or more of input keys, a touch panel, buttons, and switches. The output interface may include, for example, one or more of a display, a speaker, and a lamp. The operation unit 100 accepts a user input via the input interface, and transmits an instruction signal or data corresponding to the accepted user input to the control apparatus 400. Also, based on a command received from the control apparatus 400, the operation unit 100 outputs information from the output interface (e.g., causes the display to display an image, or causes the speaker to output a sound).

### (2) Image-Forming Apparatus

The image-forming apparatus 200 is an apparatus that prints an image on a sheet and outputs the printed sheet (also referred to a printer). In the present embodiment, the image-forming apparatus 200 is a color printer capable of forming a color image. In another embodiment, the image-forming apparatus 200 may be a monochrome printer. The image-forming apparatus 200 includes image-forming units 300Y, 300M, 300C, and 300K, an intermediate transfer member 306, a transfer unit 307, a fixing device 308, a cleaner 309, paper feeding cassettes 311 and 312, and a feeding mechanism.

The image-forming unit 300Y forms a yellow (Y) toner image on the intermediate transfer member 306. The image-forming unit 300M forms a magenta (M) toner image on the intermediate transfer member 306. The image-forming unit 300C forms a cyan (C) toner image on the intermediate transfer member 306. The image-forming unit 300K forms a black (K) toner image on the intermediate transfer member 306. As the image-forming units 300Y, 300M, 300C, and 300K are configured in the same way, a configuration of the image-forming unit 300Y will be described here as an example. The image-forming unit 300Y includes a photosensitive drum 301, a charging device 302, an exposure device 303, and a developing device 304. The photosensitive drum 301 is a drum-shaped photosensitive member that has a photosensitive layer on a surface thereof. The photosensitive drum 301 rotates around a drum axis, in the direction of arrow R in the diagram. The charging device 302 evenly charges the surface of the rotating photosensitive drum 301. The exposure device 303 irradiates the photosensitive drum 301 with laser light in accordance with image data (representing a yellow image here) input from the control apparatus 400. The laser light output from the exposure device 303 scans the surface of the charged photosensitive drum 301 in the direction of the drum axis, thereby forming an electrostatic latent image on the surface of the photosensitive drum 301. The developing device 304 develops the electrostatic latent image on the photosensitive drum 301 by supplying toner (in yellow here) to the surface of the photosensitive drum 301. As a result, a toner image is formed on the surface of the photosensitive drum 301. The yellow toner image that has been formed on the surface of the photosensitive drum 301 in the image-forming unit 300Y is transferred to the intermediate transfer member 306. Furthermore, the magenta, cyan, and black toner images that have been formed on the surfaces of the photosensitive drums 301 in the image-forming units 300M, 300C, and 300K, respectively, are transferred to the intermediate transfer member 306, in sequence, in such a manner that they are overlaid on the yellow toner image. As a result, a full-color toner image is formed on the intermediate transfer member 306. The intermediate transfer member 306 is an endless belt member, and rotates in the clockwise direction in the diagram. The intermediate transfer member 306 conveys the full-color toner image to the position of the transfer unit 307 (the transfer position).

The paper feeding cassettes 311 and 312 contain a bundle of sheets. The feeding mechanism picks up a sheet from the paper feeding cassette 311 or 312, and conveys the sheet along a conveyance path 313. Under control of the control apparatus 400, the sheet is conveyed to the transfer position in harmony with a timing at which the toner image on the intermediate transfer member 306 reaches the transfer position.

The transfer unit 307 transfers the toner image carried on the intermediate transfer member 306 to the sheet at the transfer position. The fixing device 308 includes a heater and a pressurizing roller. The fixing device 308 applies heat to the toner image transferred to the sheet with use of the heater, and applies pressure to the same with use of the pressurizing roller. As a result, the toner on the sheet is melted, and the toner image is fixed to the sheet. The cleaner 309 is arranged downstream relative to the transfer position on a trajectory of the intermediate transfer member 306, and removes toner that is remaining on the intermediate transfer member 306 after the transfer of the toner image.

On the downstream side of the fixing device 308, the conveyance path 313 branches into conveyance paths 314 and 315. The sheet that has passed through the fixing device 308 is first conveyed from the conveyance path 313 to the conveyance path 315. Once the trailing edge of the sheet has entered the conveyance path 315, the conveyance direction is reversed, and the sheet is discharged to the inspection apparatus 500 via a discharge roller 317. Through the foregoing conveyance, the sheet is discharged in a state where a side thereof on which the image has been formed is looking down (referred to as face-down). Note that in a case where double-sided printing is performed, the sheet that has entered the conveyance path 315 is conveyed to a conveyance path 316, returns from the conveyance path 316 to the conveyance path 313, and passes through the transfer position again in such a manner that the front and back thereof have been inverted. The transfer unit 307 forms a toner image on the back side of the sheet at the transfer position, and the toner image is fixed to the sheet in the fixing device 308. The sheet with the images formed on both sides thereof is discharged to the inspection apparatus 500 via the discharge roller 317.

### (3) Control Apparatus

Based on an instruction signal received from the operation unit 100 or an external network, the control apparatus 400 controls the operations of the image-forming apparatus 200, the inspection apparatus 500, the stacker 600, and the finisher 700. The control apparatus 400 may be a part of the image-forming apparatus 200 or the inspection apparatus 500. For example, in a case where the user has issued an instruction for executing a print job, the control apparatus 400 controls the image-forming apparatus 200 so as to print an image based on input image data that has been designated on a sheet. The details of a configuration of the control apparatus 400 will be further described below.

### (4) Inspection Apparatus

The inspection apparatus 500 includes a conveyance path 501, a conveyance roller 502, a feed scanning glass 503a, a feed scanning glass 503b, a conveyance roller 504, a first reading unit 505a, a second reading unit 505b, and an inspection control unit 510. The conveyance roller 502 receives a sheet output from the image-forming apparatus 200 (also referred to as a printed sheet), and conveys the sheet along the conveyance path 501. The first reading unit 505a generates a read image by optically reading a lower side of the sheet passing over the feed scanning glass 503a, and outputs read image data to the inspection control unit 510. The first reading unit 505a irradiates the sheet with white light from, for example, one or more white light-emitting diodes (LEDs). The first reading unit 505a can read an image of the sheet by detecting reflected light that has been reflected off the lower side of the sheet with use of, for example, a pixel array in a complementary metal-oxide-semiconductor (CMOS) sensor. Typically, the first reading unit 505a decomposes the reflected light from the sheet into three color components with use of RGB color filters, and receives the same. Therefore, the read image data output from the first reading unit 505a is data in a raster format in which a three-dimensional vector having three RGB color-component values is indicated on a per-pixel basis. The second reading unit 505b generates a read image by optically reading an upper side of the sheet passing underneath the feed scanning glass 503b, and outputs read image data to the inspection control unit 510. The second reading unit 505b may be configured similarly to the first reading unit 505a, and the read image data output from the second reading unit 505b is also data in a raster format in which a three-dimensional vector having three RGB color-component values is indicated on a per-pixel basis. The conveyance roller 504 discharges the sheet that has passed through the feed scanning glasses 503a and 503b to the stacker 600. The inspection control unit 510 controls the foregoing operations of the inspection apparatus 500 in coordination with the control apparatus 400. The details of a configuration of the inspection control unit 510 will be further described below.

### (5) Stacker

The stacker 600 includes conveyance paths 601, 602, 603, and 604, a large-capacity tray 610, and a purge tray 620. The stacker 600 receives, on the conveyance path 601, a sheet that has been passed from the inspection apparatus 500. The conveyance path 601 branches into the conveyance path 602 heading toward the large-capacity tray 610, the conveyance path 603 heading toward the purge tray 620, and the conveyance path 604 heading toward the finisher 700. For example, a printed sheet for which the inspection apparatus 500 has detected a fault (hereinafter referred to as a fault sheet) can be discharged to the purge tray 620 after taking a route of the conveyance path 603 under control of the control apparatus 400. Also, a sheet that requires post-processing by the finisher 700 can be discharged to the finisher 700, and other sheets can be discharged to the large-capacity tray 610.

### (6) Finisher

The finisher 700 is a post-processing apparatus that includes a conveyance path 701 and discharge trays 711, 712, and 713. The finisher 700 receives, on the conveyance path 701, a sheet that has been passed from the stacker 600, and discharges the sheet to one of the discharge trays 711, 712, and 713 under control of the control apparatus 400. Although not illustrated, the finisher 700 may include a mechanism for executing various types of post-processing, like staple processing, bookbinding processing, or trimming processing, with respect to a plurality of sheets.

### 2. Exemplary Configuration of Control Apparatus

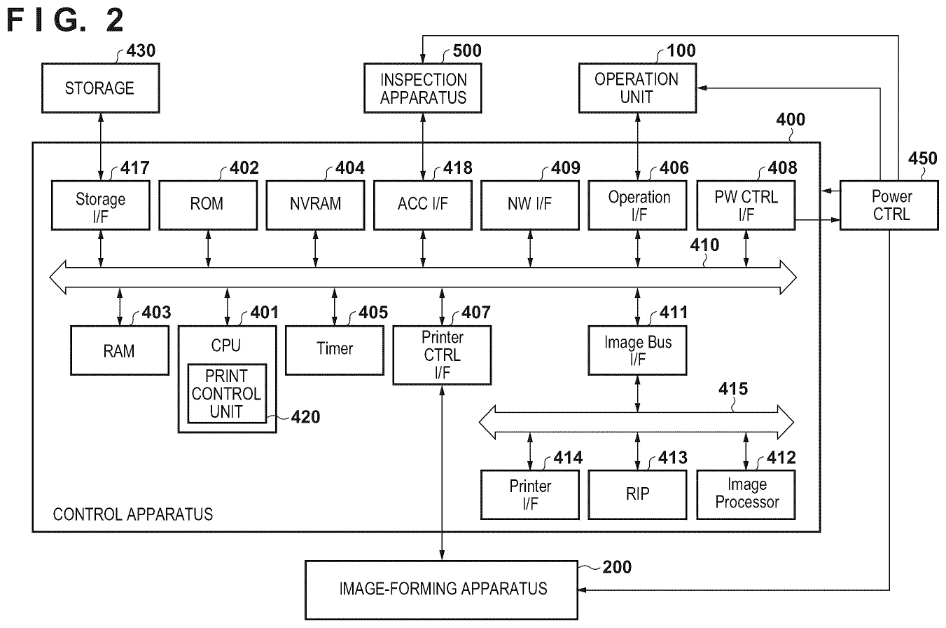

FIG. 2 is a block diagram showing an example of a configuration of the control apparatus 400. Although the above-described operation unit 100, image-forming apparatus 200, inspection apparatus 500, stacker 600, and finisher 700 are connected to the control apparatus 400, the connection relationship among the control apparatus 400, the stacker 600, and the finisher 700 is omitted in FIG. 2. A storage 430 and a power control unit 450 are further connected to the control apparatus 400.

The control apparatus 400 includes a CPU 401, a ROM 402, a RAM 403, an NVRAM 404, and a timer 405. The central processing unit (CPU) 401 is a processor that controls overall operations of the inspection system 1 by executing computer programs including software instructions. The read-only memory (ROM) 402 is a nonvolatile memory that stores one or more computer programs executed by the CPU 401. The random-access memory (RAM) 403 is a volatile memory that provides a temporary storage area for processing by the CPU 401. The RAM 403 may be used also as an image memory that temporarily stores image data. The non-volatile RAM (NVRAM) 404 is a small-scale nonvolatile memory that stores values of various parameters required for control on the operations of the inspection system 1. The timer 405 is used to obtain a current time, and to monitor an elapse of a set time period. The CPU 401, the ROM 402, the RAM 403, the NVRAM 404, and the timer 405 are connected to one another via a system bus 410.

The control apparatus 400 further includes such interfaces (I/Fs) as an operation I/F 406, a printer control I/F 407, a power control I/F 408, a network I/F 409, an image bus I/F 411, a storage I/F 417, and an ACC I/F 418. These interfaces are also connected to one another via the system bus 410. The operation I/F 406 connects the control apparatus 400 to the operation unit 100. The printer control I/F 407 is an interface that mediates control communication between the control apparatus 400 and the image-forming apparatus 200. The power control I/F 408 connects the control apparatus 400 to the power control unit 450. In accordance with a command input from the CPU 401 via the power control I/F 408, the power control unit 450 causes a power source (not illustrated) to supply power to each apparatus composing the inspection system 1 in a timely manner. The network I/F 409 connects the control apparatus 400 to an external network (not illustrated). The control apparatus 400 can communicate with an external apparatus (e.g., a host computer) via the network I/F 409. The network I/F 409 may be, for example, a wired local area network (LAN) interface or a wireless LAN interface. For example, input image data (e.g., page description language (PDL) data) required for the execution of a print job can be received from the external apparatus via the network I/F 409. The network I/F 409 may have a memory that stores parameters for communication control, such as address information (e.g., a MAC address and an IP address) of the control apparatus 400. The image bus I/F 411 is a bridge that mediates connection between the system bus 410 and an image bus 415. Th storage I/F 417 connects the control apparatus 400 to the storage 430. The storage 430 is a large-capacity storage apparatus. The storage 430 may be, for example, a hard disk drive (HDD) or a solid state drive (SSD). The ACC I/F 418 connects the control apparatus 400 to the inspection apparatus 500.

The control apparatus 400 further includes an image processor 412, an RIP 413, and a printer I/F 414. The image bus I/F 411, the image processor 412, the RIP 413, and the printer I/F 414 are connected to one another via the image bus 415. The image processor 412 executes, for example, image processing, like compression or decompression of image data according to some sort of image compression method, rotation for modifying image skew, correction of pixel values, color space conversion, or resolution conversion, with respect to image data. The raster image processor (RIP) 413 expands PDL data to image data (RIP data) in a raster format (also referred to as a bitmap format). The printer I/F 414 is an interface that mediates communication of image data between the control apparatus 400 and the image-forming apparatus 200. Input image data of a print job is rasterized and converted into RIP data by the RIP 413, is further processed by the image processor 412 (e.g., conversion from an RGB color space into a YMCK color space), and is then output to the image-forming apparatus 200 via the printer I/F 414.

In the present embodiment, the CPU 401 of the control apparatus 400 functions as a print control unit 420 that controls print operations of the image-forming apparatus 200. The print control unit 420 causes the image-forming apparatus 200 to execute a print job in an operation mode that is selected by the user from among a plurality of operation modes including a first operation mode and a second operation mode. Here, the first operation mode is a real printing mode, and the second operation mode is a test printing mode. These operation modes will be described in detail below.

### 3. Exemplary Configuration of Inspection Control Unit

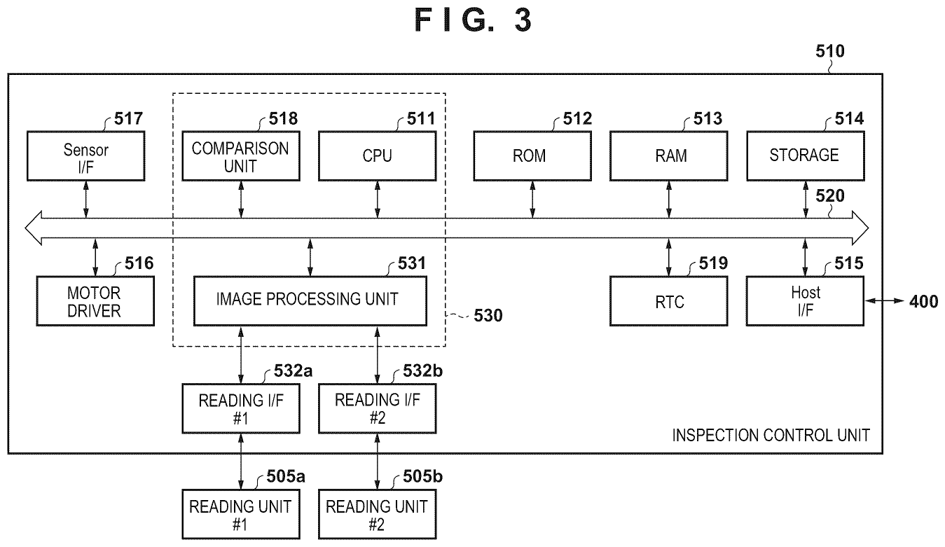

FIG. 3 is a block diagram showing an example of a configuration of the inspection control unit 510. The inspection control unit 510 includes a CPU 511, a ROM 512, a RAM 513, a storage 514, a host I/F 515, a motor driver 516, a sensor I/F517, a comparison unit 518, an RTC 519, and an image processing unit 531.

The CPU 511 is a processor that controls operations of the inspection apparatus 500 by executing computer programs including software instructions. The ROM 512 is a nonvolatile memory that stores one or more computer programs executed by the CPU 511. The RAM 513 is a volatile memory that provides a temporary storage area for processing by the CPU 511. The RAM 513 may be used also as an image memory that temporarily stores image data. The storage 514 can be, for example, a storage apparatus like an HDD or an SSD, and can store various types of data. The host I/F 515 connects the inspection control unit 510 to the ACC I/F 418 of the control apparatus 400. For example, in a case where an image that requires an inspection is printed, the host I/F 515 receives input image data (RIP data) in a raster format corresponding to that image from the control apparatus 400. The received input image data is stored into the storage 514 as reference image data representing a reference image for an inspection, which will be described below. Note that instead of input image data of a print job, read image data obtained by optically reading, in advance, a printed sheet on which the reference image has been adequately printed, may be handled as the reference image data.

Under control of the CPU 511, the motor driver 516 drives a motor (not illustrated) for rotating a plurality of rollers in the inspection apparatus 500 so that a sheet is conveyed at an appropriate timing along the conveyance path inside the inspection apparatus 500. The sensor I/F 517 connects the inspection control unit 510 to a sensor for detecting a position of a sheet passing through the conveyance path 501. In order to inspect a printed sheet, the comparison unit 518 compares a read image represented by read image data with a reference image. The inspection based on the image comparison in the comparison unit 518 will be further described below. The real time clock (RTC) 519 is a clock that measures real time with high accuracy. Synchronization between sheet conveyance and image reading in the inspection apparatus 500 can be maintained based on time measurement by the RTC 519. The CPU 511, the ROM 512, the RAM 513, the storage 514, the host I/F 515, the motor driver 516, the sensor I/F 517, the comparison unit 518, the RTC 519, and the image processing unit 531 are connected to one another via a system bus 520.

The inspection control unit 510 further includes a first reading I/F 532a and a second reading I/F 532b. The first reading I/F 532a connects the inspection control unit 510 to the first reading unit 505a shown in FIG. 1. The first reading I/F 532a obtains read image data of the first side (the lower side in FIG. 1) of a sheet from the first reading unit 505a, and outputs the obtained read image data to the image processing unit 531. The second reading I/F 532b connects the inspection control unit 510 to the second reading unit 505b shown in FIG. 1. The second reading I/F 532b obtains read image data of the second side (the upper side in FIG. 1) of the sheet from the second reading unit 505b, and outputs the obtained read image data to the image processing unit 531. The image processing unit 531 executes, for example, such image processing as variable magnification and gamma correction with respect to the pieces of read image data obtained via the first reading I/F 532a and the second reading I/F 532b. Then, the image processing unit 531 outputs the processed pieces of read image data to the RAM 513 for the purpose of, for example, comparison between a read image and a reference image. Note that the CPU 511, the comparison unit 518, and the image processing unit 531 will be collectively referred to as an inspection unit 530 in the description provided hereafter. No limitation is intended by the above-described example, and the inspection unit 530 may alternatively be realized as a single processing circuit.

### 4. Real Printing Mode and Test Printing Mode

As described above, the print control unit 420 controls the image-forming apparatus 200 so as to execute a print job in an operation mode that is selected by the user from among the real printing mode and the test printing mode. In the real printing mode, the print control unit 420 causes the image-forming apparatus 200 to execute an entirety of a print job involving a plurality of sheets. In the test printing mode, the print control unit 420 causes the image-forming apparatus 200 to partially attempt the print job involving the plurality of sheets. The part printed in the test printing mode may be an M part out of the total number of copies N (N and M are natural numbers, N>M), may be Q pages out of the number of pages P (P and Q are natural numbers, P>Q), or may be a combination of these.

Typically, the user causes the inspection system 1 to execute the entirety of the print job in the real printing mode after checking that printing has been performed without error with an acceptable quality in the test printing mode. In both of the real printing mode and the test printing mode, the inspection unit 530 executes an inspection on a printed sheet output from the image-forming apparatus 200, and outputs inspection result data indicating the result of the inspection. The inspection executed by the inspection unit 530 will be further described below. As a result of the inspection unit 530 executing an inspection and outputting inspection result data also in the test printing mode, the user can efficiently judge whether a preparation for real printing has been appropriately done by looking at the inspection result data.

In a case where a fault has been detected as a result of an inspection in the real printing mode, the print control unit 420 causes the image-forming apparatus 200 to re-print an image corresponding to a fault sheet. As described above, the fault sheet can be discharged to the purge tray 620 of the stacker 600. In a case where two or more printed sheets are to be output in the real printing mode, if a fault has been detected as a result of an inspection on a certain printed sheet, the print control unit 420 causes the image-forming apparatus 200 to execute re-printing, and then continue printing on a succeeding sheet(s). In this way, in the real printing mode, re-printing is automatically performed based on an inspection result; therefore, even in a case where a large number of pages or a large number of copies are printed at a time, such as on an occasion of commercial printing, a complete set of print materials with no fault can be provided to the user.

The inspection unit 530 re-inspects a printed sheet that is output from the image-forming apparatus 200 as a result of re-printing of an image (re-forming of an image) corresponding to a fault sheet. In a case where the number of times the same image has been re-printed by the image-forming apparatus 200 has reached an upper limit, the print control unit 420 does not cause the image-forming apparatus 200 to re-print this image, even if a fault has been detected in a re-inspection. By thus setting the upper limit for the number of times re-printing is performed, unnecessary repetition of re-printing attributed to the same fault can be prevented.

In a case where a fault has been detected as a result of an inspection in the test printing mode, the print control unit 420 does not cause the image-forming apparatus 200 to re-print an image corresponding to a fault sheet. This is because, in test printing, a fault is easily detected due to a variety of causes, such as an error in a print setting and an error in an inspection setting, and uniform execution of re-printing leads to not only a waste of consumable materials, such as sheets and toner, but also an unnecessary increase in the amount of work. In a case where two or more printed sheets are to be output in the test printing mode, if a fault has been detected as a result of an inspection on a certain printed sheet, whether to continue printing on a succeeding sheet(s) may be controlled depending on the type of the fault described below.

Note that in a certain practical example described below, re-printing can be executed at the time of detection of a fault also in the test printing mode depending on a user setting. In a case where the number of times the same image has been re-printed has reached an upper limit in the test printing mode, the print control unit 420 does not cause the image-forming apparatus 200 to re-print this image, similarly to the real printing mode. The upper limit for the number of times re-printing is performed in this practical example may be different from the upper limit imposed on the number of times re-printing is performed in the real printing mode.

### 5. Image Inspection and Variable Inspection

### <5-1. Image Inspection>

In the present embodiment, the inspection unit 530 inspects each of printed sheets output from the image-forming apparatus 200 by comparing a read image of this printed sheet with a reference image. In the present specification, this inspection is referred to as an image inspection. For example, the inspection unit 530 may detect a fault in a printed sheet in a case where a result of comparison between a read image and the reference image satisfies at least one of the following fault conditions:
a stain or a streak that is not present in the reference image is present in the read image;
the difference in color tones between the read image and the reference image exceeds a threshold; and
a positional shift between the read image and the reference image exceeds a threshold.

A fault detected in such an image inspection will be referred to as a first type of fault in the present specification. The first type of fault is based on inconsistency between the read image and the reference image. In a case where the result of comparison does not satisfy any fault condition, the inspection unit 530 can determine that there is no fault in the printed sheet.

With regard to the image inspection, the user may set an inspection area, an inspection level, and an excluded area. The inspection area is a partial area in which the inspection is to be performed inside the read image. The inspection level represents the extent of inconsistency between the read image and the reference image that is to be detected as a fault. A threshold to be compared with the size of the stain or the streak, the difference in color tones, or the positional shift that is regarded as a fault in the above-described fault conditions can be decided in accordance with the inspection level set by the user. Different inspection levels may be set for different inspection areas. As an example, the inspection level is represented by a numerical value from 1 to 3 or from 1 to 5, and a larger numerical value means that a finer inspection is performed (or vice versa). The excluded area is a partial area inside the read image for which the inspection is not to be performed.

### <5-2. Variable Inspection>

The inspection unit 530 may be capable of performing the following variable inspection in addition to (or in place of) the above-described image inspection. The variable inspection denotes an inspection of whether a specific element that is variably set by the user exists inside a read image. The specific element can include, for example, at least one of a character string and a code in which information is encoded. For example, the inspection unit 530 can search for a specific character string inside an inspection area that is set by the user in advance with use of optical character recognition (OCR) technology, and determine that there is a fault in a printed sheet if the existence of this specific character string has not been detected. The character string may be variable, like a serial number that is counted up per copy. Similarly, the inspection unit 530 can search for a code, like a barcode or a QR Code™, inside an inspection area that is set by the user in advance with use of known code detection technique, and determine that there is a fault in a printed sheet if the existence of the specific code has not been detected.

A fault detected in such a variable inspection will be referred to as a second type of fault in the present specification. The second type of fault is based on non-detection of the specific element in an inspection area set by the user. In a case where an intended element has been found inside the inspection area, the inspection unit 530 can determine that there is no fault in the printed sheet.

In a case where two or more printed sheets are to be output in the test printing mode, if the second type of fault has been detected as a result of an inspection on a certain printed sheet, the print control unit 420 may cause the image-forming apparatus 200 to abort printing on a succeeding sheet(s). This is because the cause of the failure to correctly recognize the specific element, like a character string or a code, is often a setting mistake made by the user, like an error in the position of the inspection area or an error in designation of the character string or the code. In a case where such a setting mistake has been made, it is desirable to immediately abort test printing and suggest the user to modify settings. On the other hand, if the first type of fault has been detected as a result of an inspection on a certain printed sheet, the print control unit 420 may cause the image-forming apparatus 200 to continue printing on a succeeding sheet(s). This is because the first type of fault, such as a stain and a streak, is not necessarily reproduced on the succeeding sheet(s). It is also considered that the result of printing on the succeeding sheet(s) plays a useful role in judging the cause of the fault.

### 6. Examples of Setting Screens

### <6-1. Print Setting Screen>

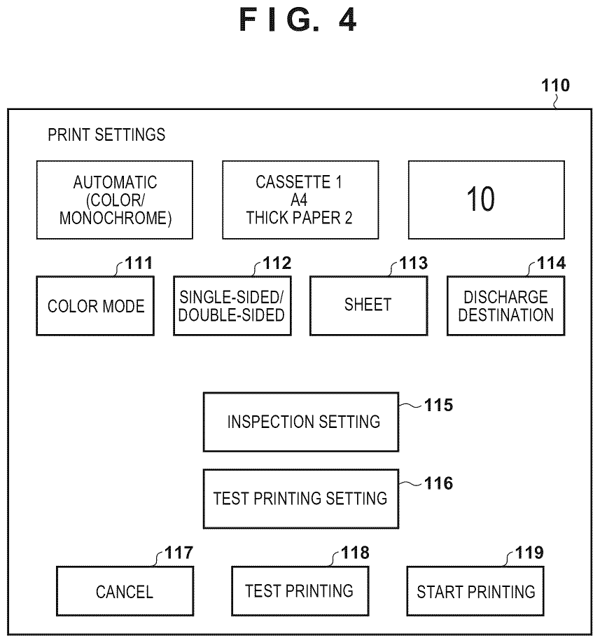

FIG. 4 is an explanatory diagram showing an example of a print setting screen according to an embodiment. A print setting screen 110 shown in FIG. 4 can be displayed on the display of the operation unit 100 or an external apparatus when, for example, the user instructs the inspection system 1 to execute a print job. The print setting screen 110 includes a first setting button 111, a second setting button 112, a third setting button 113, a fourth setting button 114, an inspection setting button 115, a test printing setting button 116, a cancel button 117, a test printing button 118, and a printing start button 119.

The first setting button 111 is a button for setting a color mode (color or monochrome). The second setting button 112 is a button for setting single-sided printing or double-sided printing. The third setting button 113 is a button for setting a category of a sheet to be used in printing. Display of such information as a size and a basis weight of sheets contained in each cassette, and changing of a cassette to be used, may be enabled in response to an operation on the third setting button 113. The fourth setting button 114 is a button for setting to which discharge tray a sheet is to be discharged.

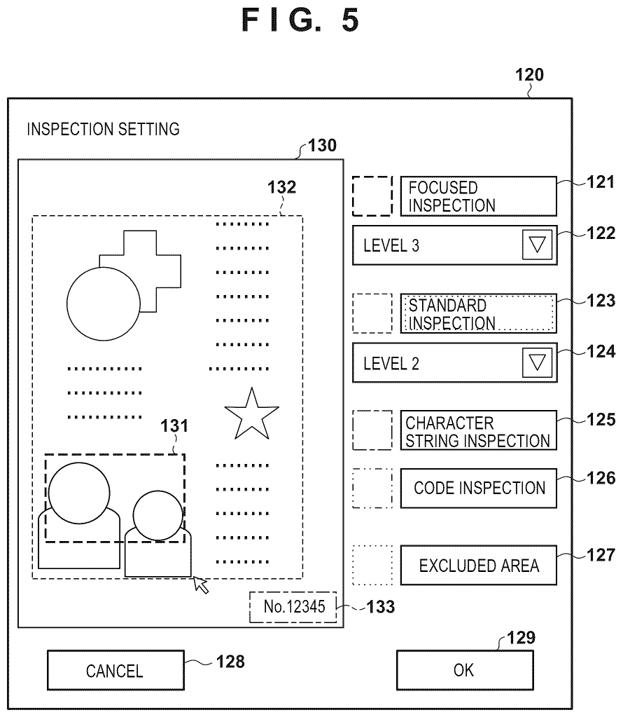

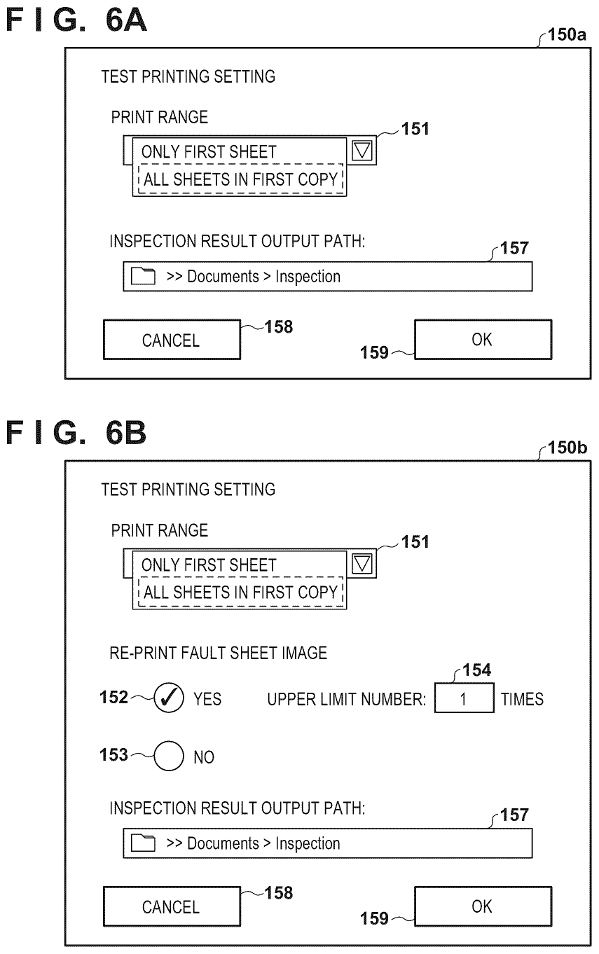

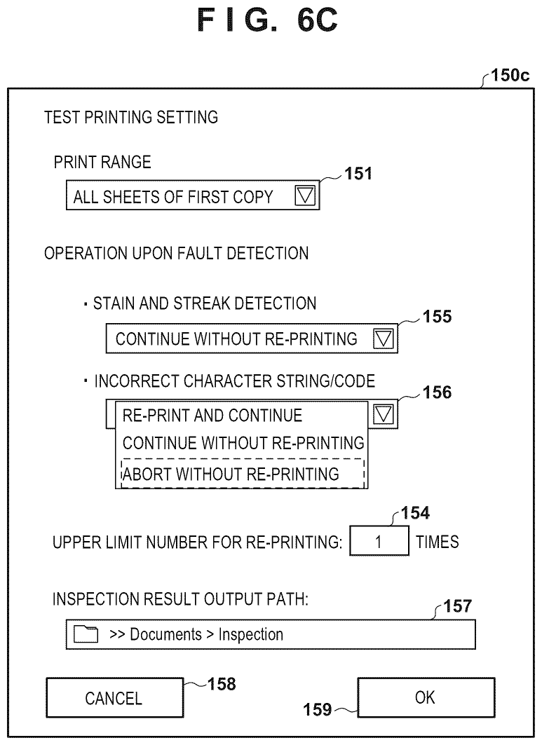

The inspection setting button 115 is a button for calling up an inspection setting screen, which will be described below. When the user has operated the inspection setting button 115, the inspection setting screen, which will be described below using FIG. 5, is called up. The test printing setting button 116 is a button for calling up a test printing setting screen, which will be described below. When the user has operated the test printing setting button 116, the test printing setting screen, which will be described below using FIG. 6A to FIG. 6C, is called up.

The cancel button 117 is a button for cancelling the execution of the print job and closing the print setting screen 110. The test printing button 118 is a button for starting test printing, that is to say, a partial attempt for the print job. The printing start button 119 is a button for starting the execution of real printing, that is to say, the entirety of the print job.

### <6-2. Inspection Setting Screen>

FIG. 5 is an explanatory diagram showing an example of an inspection setting screen. An inspection setting screen 120 includes a first button 121, a first level selection field 122, a second button 123, a second level selection field 124, a third button 125, a fourth button 126, a fifth button 127, a cancel button 128, an OK button 129, and an area designation section 130.

The area designation section 130 displays a preview of an input image of a print job. The user can set a focused inspection area in which a focused inspection is to be performed by operating the first button 121 and designating (e.g., by dragging) an intended range in the area designation section 130. Also, the user can select an inspection level of the focused inspection area using the first level selection field 122. Similarly, the user can set a standard inspection area in which a standard inspection is to be performed by operating the second button 123 and designating an intended range in the area designation section 130. Furthermore, the user can select an inspection level of the standard inspection area using the second level selection field 124. These inspection areas are targets of an image inspection.

In addition, the user can set a character string inspection area in which a character string is to be inspected by operating the third button 125 and designating an intended range in the area designation section 130. Moreover, the user can set a code inspection area in which a code is to be inspected by operating the fourth button 126 and designating an intended range in the area designation section 130. These inspection areas are targets of a variable inspection. Although not illustrated in FIG. 5, further detailed setting screens for the user to designate a character string and a code to be searched for in the respective inspection areas can be provided.

The user can set an excluded area to be excluded from the inspections by operating the fifth button 127 and designating an intended range in the area designation section 130. A part that has been set as an excluded area can be an exception for targets of the image inspection and the variable inspection.

In the example of FIG. 5, one focused inspection area 131, one standard inspection area 132, and one character string inspection area 133 are set inside the image as indicated by respective frames in the area designation section 130.

Although not illustrated in FIG. 5, the inspection setting screen 120 may include additional buttons for causing the preview of the area designation section 130 to make a transition among a plurality of pages. The cancel button 128 is a button for cancelling the changes in the settings and returning to the print setting screen 110. The OK button 129 is a button for registering the changes in the settings with the system and returning to the print setting screen 110.

### <6-3. Test Printing Setting Screen>

FIG. 6A to FIG. 6C are explanatory diagrams showing first to third examples of a test printing setting screen, respectively. In the first example of FIG. 6A, a test printing setting screen 150a includes a range selection field 151, a file path input field 157, a cancel button 158, and an OK button 159.

Using the range selection field 151, the user can select a test printing range from among the options of “first sheet only” and “all sheets in first copy”, for example. The file path input field 157 is a field that accepts an input of a file path that acts as an output destination of a data file of inspection result data. Note that the inspection result data may be not only output as the data file, but also displayed on an inspection result screen. The cancel button 158 is a button for cancelling the changes in the settings and returning to the print setting screen 110. The OK button 159 is a button for registering the changes in the settings with the system and returning to the print setting screen 110.

In the first example, even if a fault has been detected as a result of an inspection in the test printing mode, re-printing of an image corresponding to a fault sheet is not performed. In contrast, in the second example, the user can set whether to perform re-printing of the image corresponding to the fault sheet in the test printing mode.

In the second example of FIG. 6B, a test printing setting screen 150b includes a range selection field 151, radio buttons 152 and 153, an upper limit number input field 154, a file path input field 157, a cancel button 158, and an OK button 159.

The radio buttons 152 and 153 are buttons that accept a selection of whether to perform re-printing of the image corresponding to the fault sheet. The user who wishes to perform re-printing selects the radio button 152, whereas the user who does not wish to perform re-printing selects the radio button 153. The upper limit number input field 154 is a field that is enabled in a case where the radio button 152 has been selected, and accepts an input of an upper limit for the number of times re-printing is performed in the test printing mode. In a case where user settings indicate that the radio button 152 has been selected and therefore re-printing of the image corresponding to the fault sheet is to be performed, the print control unit 420 causes the image-forming apparatus 200 to execute re-printing of this image as long as the number of times re-printing has been performed does not exceed the upper limit. Consumption of consumable materials in test printing can be flexibly suppressed by enabling the user to set the upper limit for the number of times re-printing is performed, which is unique to the test printing mode, in the foregoing manner. On the other hand, in a case where user settings indicate that the radio button 153 has been selected and therefore re-printing is not to be performed, the print control unit 420 does not cause the image-forming apparatus 200 to execute re-printing of the image corresponding to the fault sheet.

In the next third example, the user can set, for each fault type, whether to continue or abort printing on a sheet(s) succeeding the fault sheet in the test printing mode.

In the third example of FIG. 6C, a test printing setting screen 150c includes a range selection field 151, an upper limit number input field 154, a first operation selection field 155, a second operation selection field 156, a file path input field 157, a cancel button 158, and an OK button 159.

Using the first operation selection field 155, the user can select an operation for a case where a first type of fault, such as a stain and a streak, has been detected in an image inspection. Also, using the second operation selection field 156, the user can select an operation for a case where a second type of fault, which is a failure to correctly detect a specific character string or code in a variable inspection, has been detected. The options here may be two or more of “perform re-printing and proceed”, “continue without performing re-printing”, and “abort without performing re-printing”, for example. For example, a default setting related to the first type of fault can be “continue without performing re-printing”, and a default setting related to the second type of fault can be “abort without performing re-printing”. The upper limit number input field 154 is enabled in a case where “perform re-printing and proceed” has been selected in relation to at least one of the first type of fault and the second type of fault, and accepts an input of an upper limit for the number of times re-printing is performed.

### <7. Flows of Processing>

In the present section, several examples of flows of processing that can be executed by the print control unit 420 and the inspection unit 530 will be described using flowcharts. Note that in each flowchart, “S” means a processing step.

### (1) Printing Control Processing

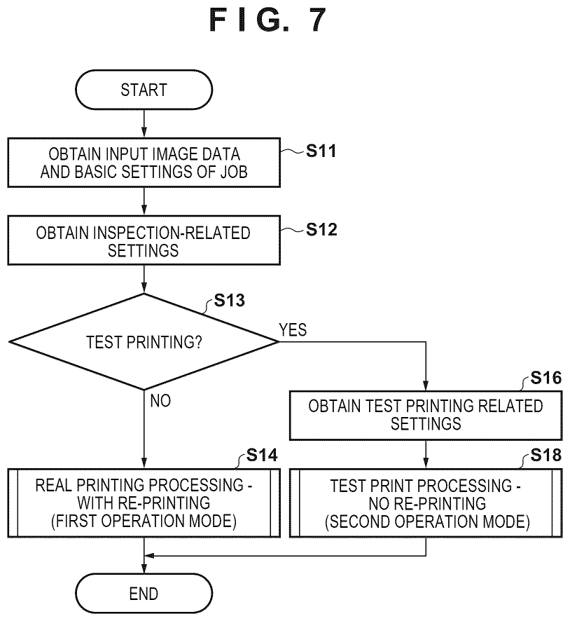

FIG. 7 is a flowchart showing an example of a flow of printing control processing according to an embodiment. The printing control processing of FIG. 7 is started in response to the user's operation on the test printing button 118 or the printing start button 119 on the print setting screen 110 of FIG. 4, for example.

First, in step S11, the print control unit 420 obtains input image data and basic settings of a print job. The basic settings can include, for example, the number of copies to be printed, a color mode, single-sided/double-sided, a category of a sheet, and a discharge destination. It is assumed here that an instruction for printing a plurality of sheets has been issued.

Next, in step S12, the print control unit 420 obtains inspection-related settings. The inspection-related settings can include, for example, one or more inspection areas set by the user, inspection levels of the respective inspection areas, inspection types of the respective inspection areas, a character string in the case of the character string inspection, a code in the case of the code inspection, and an excluded area.

Next, in step S13, the print control unit 420 determines whether the operation mode selected by the user is the real printing mode (first operation mode) or the test printing mode (second operation mode). In a case where the real printing mode has been selected, processing proceeds to step S14. On the other hand, in a case where the test printing mode has been selected, processing proceeds to step S16.

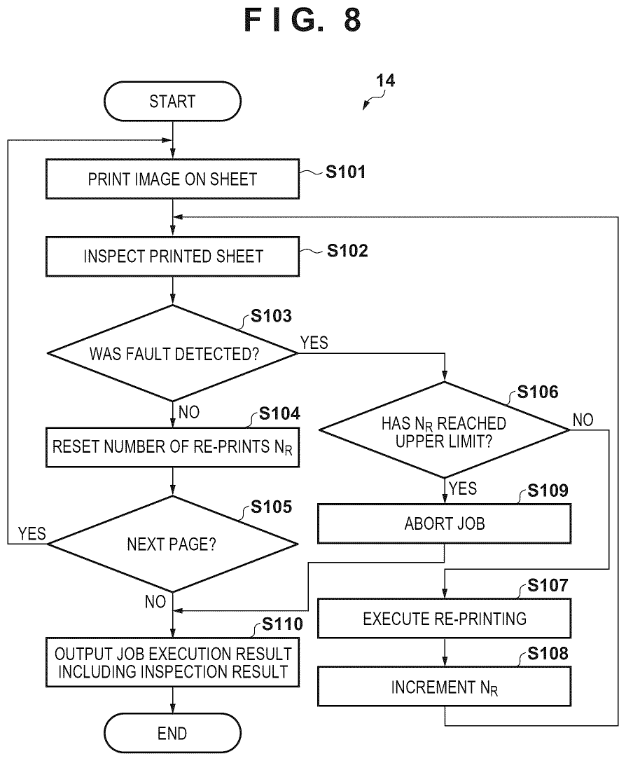

In step S14, the print control unit 420 executes real printing processing. The real printing processing executes the entirety of the print job involving the plurality of sheets; each of the printed sheets is inspected by the inspection unit 530, and re-printing is executed in a case where a fault has been detected. A more detailed flow of this real printing processing will be described below using FIG. 8.

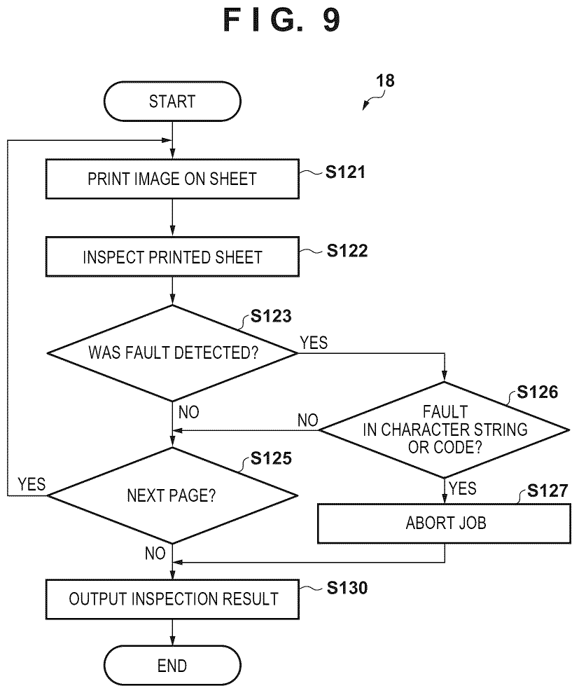

In step S16, the print control unit 420 obtains settings related to test printing. The settings related to test printing include, for example, a test printing range and an output destination of inspection result data. Next, in step S18, the print control unit 420 executes test printing processing. The test printing processing partially attempts the print job involving the plurality of sheets; although each of the printed sheets is inspected by the inspection unit 530, re-printing is not executed even in a case where a fault has been detected. A more detailed flow of this test printing processing will be described below using FIG. 9.

When the test printing processing has finished, the user modifies settings of the print job and the inspection-related settings as necessary, and instructs the inspection system 1 to perform printing in the real printing mode. When the real printing processing has finished, a complete set of print materials is provided to the user.

### (2) Real Printing Processing

FIG. 8 is a flowchart showing an example of a flow of real printing processing with re-printing, which can be executed in step S14 of FIG. 7. The real printing processing of FIG. 8 is executed by the image-forming apparatus 200 and the inspection unit 530 under control of the print control unit 420.

First, in step S101, the image-forming apparatus 200 prints an image of one page on a sheet based on input image data, and outputs the printed sheet to the inspection apparatus 500.

Next, in step S102, the inspection unit 530 inspects the printed sheet accepted from the image-forming apparatus 200. For example, the inspection unit 530 obtains read image data generated by reading the printed sheet, and performs an image inspection based on comparison between a read image and a reference image that has been obtained in advance. Also, the inspection unit 530 performs a character string inspection by searching for a specific character string inside a character string inspection area in accordance with inspection-related settings. Furthermore, the inspection unit 530 performs a code inspection by searching for a specific code inside a code inspection area in accordance with the inspection-related settings. The inspection unit 530 outputs an inspection result to the print control unit 420.

Thereafter, processing branches in step S103 depending on whether a fault has been detected as a result of the inspection. In a case where a fault has not been detected on the printed sheet, processing proceeds to step S104. On the other hand, in a case where a fault has been detected on the printed sheet, processing proceeds to step S106.

In step S104, the print control unit 420 resets a variable NR, which represents the number of times re-printing has been performed, to zero. Note that an initial value of the variable NR is zero. The printed sheet for which a fault has not been detected, that is to say, which has been determined to be normal, is discharged to a discharge destination indicated by basic settings. Next, in step S105, the print control unit 420 determines whether the next page to be printed remains. In a case where the next page to be printed remains, processing returns to step S101, an image of the next page is printed on a new sheet, and the inspection of step S102 is performed with respect to the printed sheet. In a case where the next page to be printed does not remain, processing proceeds to step S110.

In step S106, the print control unit 420 determines whether the variable NR, which represents the number of times re-printing has been performed, has reached a predetermined upper limit. In a case where the variable NR has not reached the upper limit, the print control unit 420 causes the image-forming apparatus 200 to execute re-printing of the image corresponding to the fault sheet in step S107. The fault sheet is discharged to the purge tray 620. Next, in step S108, the print control unit 420 increments (adds 1 to) the variable NR. Then, processing returns to step S102, and the inspection unit 530 performs re-inspection with respect to the printed sheet output from the image-forming apparatus 200. In a case where the variable NR has reached the upper limit, the print control unit 420 aborts the execution of the print job in step S109. Then, processing proceeds to step S110.

In step S110, the print control unit 420 outputs a job execution result, which includes a result of the inspection on the printed sheets of the respective pages, by writing the same to a data file or displaying the same on the screen, for example.

### (3) Test Printing Processing

FIG. 9 is a flowchart showing an example of a flow of test printing processing twithout re-printing, which can be executed in step S18 of FIG. 7. The test printing processing of FIG. 9 is executed by the image-forming apparatus 200 and the inspection unit 530 under control of the print control unit 420.

First, in step S121, the image-forming apparatus 200 prints an image of one page on a sheet based on input image data, and outputs the printed sheet to the inspection apparatus 500.

Next, in step S122, the inspection unit 530 inspects the printed sheet accepted from the image-forming apparatus 200. For example, the inspection unit 530 obtains read image data generated by reading the printed sheet, and performs an image inspection based on comparison between a read image and a reference image that has been obtained in advance. Also, the inspection unit 530 performs a character string inspection by searching for a specific character string inside a character string inspection area in accordance with inspection-related settings. Furthermore, the inspection unit 530 performs a code inspection by searching for a specific code inside a code inspection area in accordance with the inspection-related settings. The inspection unit 530 outputs an inspection result to the print control unit 420.

Thereafter, processing branches in step S123 depending on whether a fault has been detected as a result of the inspection. In a case where a fault has not been detected on the printed sheet, processing proceeds to step S125. On the other hand, in a case where a fault has been detected on the printed sheet, processing proceeds to step S126.

In step S125, the print control unit 420 determines whether the next page to be printed remains. In a case where the next page to be printed remains, processing returns to step S121, an image of the next page is printed on a new sheet, and the inspection of step S122 is performed with respect to the printed sheet. In a case where the next page to be printed does not remain, or the test printing range is only the first sheet, processing proceeds to step S130.

In step S126, the print control unit 420 determines whether the detected fault is the second type of fault, that is to say, a fault in a character string or a code. In a case where the detected fault is not the second type of fault, but the first type of fault, test printing is continued, and processing proceeds to step S125. In a case where the detected fault is the second type of fault, processing proceeds to step S127. In step S127, the print control unit 420 aborts the execution of the print job. Then, processing proceeds to step S130.

In step S130, the print control unit 420 outputs a result of the inspection on the printed sheets of the respective pages by writing the same to a data file or displaying the same on the screen, for example.

### (4) Printing Control Processing-Modification Example

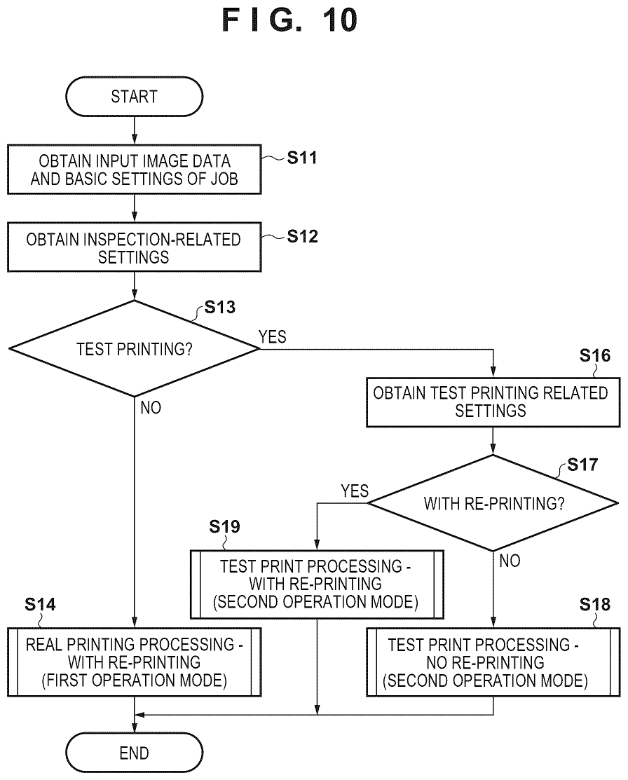

FIG. 10 is a flowchart showing an example of a flow of printing control processing according to a modification example. Unlike the example of FIG. 7, in the present modification example, the user can set whether to perform re-printing of an image corresponding to a fault sheet in the test printing mode. The printing control processing of FIG. 10 is started in response to the user's operation on the test printing button 118 or the printing start button 119 on the print setting screen 110 of FIG. 4, for example.

As steps S11 to S16 are processing steps that are the same as those described using FIG. 7, descriptions thereof are omitted here.

After the user has selected the test printing mode (second operation mode) and obtained settings related to test printing in step S16, the print control unit 420 determines in step S17 whether user settings indicate that re-printing of an image corresponding to a fault sheet should be performed.

In a case where the user settings indicate that re-printing of the image corresponding to the fault sheet should not be performed, the print control unit 420 executes the test printing processing, which has been described in detail using FIG. 9, in step S18.

In a case where the user settings indicate that re-printing of the image corresponding to the fault sheet should be performed, the print control unit 420 executes test printing processing with re-printing in step S19. The flow of the test printing processing here may be similar to the flow of the real printing processing described using FIG. 8. Note that the range of sheets to be printed is not all of sheets determined from the number of copies to be printed and the number of pages of input image data in basic settings, but only a part thereof.

When the test printing processing has finished, the user modifies settings of the print job and the inspection-related settings as necessary, and instructs the inspection system 1 to perform printing in the real printing mode. When the real printing processing has finished, a complete set of print materials is provided to the user.

### 8. Summary

Thus far, various embodiments, practical examples, and modification examples of the technology according to the present disclosure have been described using FIG. 1 to FIG. 10. According to the above-described embodiments, in an inspection system, an image-forming unit prints an image on a sheet, and an inspection unit inspects the printed sheet. A control unit of the inspection system controls the image-forming unit to operate in an operation mode that is selected by the user from among a first operation mode that executes an entirety of a print job involving a plurality of sheets, and a second operation mode that partially attempts the print job. In both of the first operation mode and the second operation mode, the inspection unit executes an inspection on the printed sheet output from the image-forming unit. In the first operation mode, the control unit causes the image-forming unit to re-print an image corresponding to a printed sheet on which a fault has been detected as a result of the inspection; on the other hand, in the second operation mode, the control unit does not cause the image-forming unit to re-print the image corresponding to a printed sheet on which a fault has been detected as a result of the inspection. Therefore, a waste of consumable materials, such as sheets and toner, and an unnecessary increase in the amount of work can be prevented at the time of a partial attempt for a print job in which a fault is often detected due to inappropriate settings made by the user.

Also, according to the above-described embodiments, in both of the first operation mode and the second operation mode, the inspection unit outputs inspection result data indicating the result of an inspection that has been executed with respect to a printed sheet output from the image-forming unit. Therefore, the user can check, on the data, whether a print material output through test printing has no problem without relying only on a visual sense, and sufficiently discover points to be improved, such as re-examination of settings. As a result, the possibility of the occurrence of a fault in real printing is reduced, and printing of a large number of pages or a large number of copies can be efficiently carried out.

### 9. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-124834, filed on Jul. 31, 2024, which is hereby incorporated by reference herein in its entirety.

What is claimed is:

1. An inspection system, comprising:
an image-forming unit configured to form an image on a sheet;
an inspection unit configured to inspect a sheet on which an image has been formed; and
a control unit configured to control the image-forming unit so as to form an image on a sheet in a first operation mode that executes an entirety of a print job for forming an image on a plurality of sheets, or in a second operation mode that partially attempts the print job,
wherein the inspection unit is configured to, in both of the first operation mode and the second operation mode, execute an inspection on a sheet on which an image has been formed by the image-forming unit, and
the control unit is configured to
in a case where a fault has been detected as a result of the inspection, in the first operation mode, cause the image-forming unit to re-form an image corresponding to a sheet on which the fault has been detected, and
in a case where a fault has been detected as a result of the inspection, in the second operation mode, not cause the image-forming unit to re-form an image corresponding to a sheet on which the fault has been detected.

2. The inspection system according to claim 1, wherein the inspection unit is configured to, in both of the first operation mode and the second operation mode, output inspection result data indicating a result of the inspection that has been executed with respect to a sheet on which an image has been formed by the image-forming unit.

3. The inspection system according to claim 1, further comprising:
a reading unit configured to read a sheet to generate a read image,
wherein the fault detectable by the inspection unit includes
a first type of fault based on inconsistency between the read image and a reference image that is obtained in advance, and
a second type of fault based on non-detection of a specific element in a partial area set by a user inside the read image.

4. The inspection system according to claim 3, wherein the specific element includes at least one of
a character string recognized by optical character recognition, and
a code in which information is encoded.

5. The inspection system according to claim 3, wherein the control unit is configured to, in a case where two or more sheets are to be output from the image-forming unit in the second operation mode, when the second type of fault has been detected as a result of an inspection on a certain sheet, cause the image-forming unit to abort formation of an image on a succeeding sheet.

6. The inspection system according to claim 5, wherein the control unit is configured to, in a case where two or more sheets are to be output from the image-forming unit in the second operation mode, if the first type of fault has been detected as a result of an inspection on a certain sheet, cause the image-forming unit to continue formation of an image on a succeeding sheet.

7. The inspection system according to claim 5, wherein the control unit is configured to, in a case where two or more sheets are to be output from the image-forming unit in the first operation mode, if the fault has been detected as a result of an inspection on a certain sheet, cause the image-forming unit to re-form an image corresponding to the certain sheet, and then cause the image-forming unit to continue formation of an image on a succeeding sheet.

8. The inspection system according to claim 1, wherein the control unit is configured to, in a case where a user setting indicates that an image corresponding to a sheet on which the fault has been detected should not be re-formed in the second operation mode, not cause the image-forming unit to re-form the image corresponding to the sheet on which the fault has been detected.

9. The inspection system according to claim 8, wherein the inspection unit is configured to re-inspect a sheet that is output from the image-forming unit as a result of re-formation of an image, and
the control unit is configured to, in a case where the number of times the same image has been formed by the image-forming unit in accordance with the user setting has reached an upper limit in the second operation mode, not cause the image-forming unit to re-form the image.

10. The inspection system according to claim 9, wherein the upper limit is settable by a user.

11. The inspection system according to claim 9, wherein the upper limit imposed on the number of times image re-formation is performed in the second operation mode is different from an upper limit imposed on the number of times image re-formation is performed in the first operation mode.
